(19) United States
(12) Patent Application Publication
(10) Pub. No.: US 2016/0358060 A1
(43) Pub. Date: Dec. 8, 2016

(54) PRODUCT THEFT PREVENTION TAG

(71) Applicant: Hyang Je LEE, Changwon-si (KR)

(72) Inventor: Hyang Je LEE, Changwon-si (KR)

(21) Appl. No.: 14/964,233

(22) Filed: Dec. 9, 2015

(30) Foreign Application Priority Data
Jun. 5, 2015 (KR) 10-2015-0079710

(51) Int. Cl. G06K 19/07

(52) U.S. Cl. CPC G06K 19/0723

(57) ABSTRACT

Disclosed is a product theft prevention tag including: a security key in which a security tag is installed; a security key locker that accommodates and constrains a portion of the security key to maintain a locked state, and releases the locked state when an electric voltage is applied thereto; a product constraining wire that connects the security key and the security key locker; a unique ID chip containing product information; and a power generation unit that converts light to electric power. In addition, this invention further discloses a proximity sensor that receives electric power from the power generation unit and detects proximity of a moving object; and an alarm unit that generates any one of sound and light when the proximity sensor detects the moving object.

### CROSS-REFERENCE TO RELATED APPLICATION

This application claims priority to and the benefit of Korean Patent Application No. 10-2015-0079710, filed on Jun. 5, 2015, the disclosure of which is incorporated herein by reference in its entirety.

### BACKGROUND OF THE INVENTION

Field of the Invention

The present invention relates to a product theft prevention tag, and more particularly to a product theft prevention tag that permits unmanned automatic payment by producing electric power by itself by using sunlight and releasing constraint of a security key by using a power supply thereof when a signal is received from the outside.

The present invention also relates to a product theft prevention tag that creates a purchasing need by operating a detection sensor with a power supply thereof and generating a sound when a consumer approaches the product theft prevention tag.

The present invention also relates to a product theft prevention tag that can maximize a theft prevention effect by releasing a constraint of a security key only when electric power instead of a magnetic force is supplied thereto, and can prevent loss of the security key.

Description of the Related Art

In general, wirelessly operated tags are coupled to product in places, such as large-scale markets or departments, where various articles are displayed and sold. Such coupled tags may be recognized through a tag recognizer provided at an exit, and a warning alarm is rung if a product from which the tag is not eliminated passes by the tag recognizer.

Meanwhile, Korean Utility Model No. 20-0274007 (entitled “Product Theft Prevention Apparatus”) discloses a product theft prevention apparatus that is coupled to a product to prevent theft and permit release of a coupled state when the product is purchased.

FIG. 1 is a sectional view illustrating an operational structure of the product theft prevention apparatus disclosed in Korean Utility Model No. 2-0274007.

Referring to the drawing, the related art includes an upper tag 20 and a lower tag 10 that are coupled to each other to define an internal space and have an assembly hole 21 communicated with the internal space form the outside, an electronic sensitive sensor (not illustrated) that is embedded in the interior space, a fixed member that has a locking portion 210 inserted into and fixed to the assembly hole 21 while being coupled to a product, and locking balls 13 and a spring 15 that are accommodated in the interior space to fix and release the inserted locking portion 210, and has a structure that eliminates the locking portion 210 from the upper and lower tags 20 and 10 by a separator 18 having a magnetic force.

The locking portion 210 has a groove 211 through which the locking balls 13 pass on the outer peripheral surface thereof. Accordingly, the locking portion 210 is firmly constrained while the locking balls 13 enter the groove 211.

Meanwhile, if the separator 18 including a magnet is located around the lower tag 10 when the product is normally sold, a pusher 14 and the locking balls 13 are moved along an inclined surface of a tapered cover 12 while compressing the spring 15 by a magnetic force of the separator 18.

Accordingly, the constraint of the locking portion 210 is released when the locking balls 13 are withdrawn from the groove 211 of the fixed member 200, and thus the product theft prevention apparatus is eliminated by separating the locking portion 210 from the upper and lower tags 20 and 10.

However, in the related art having the above-mentioned configuration, the movement of the locking balls 13 is determined according to the position of the permanent magnet provided in the separator 18.

Accordingly, when the locking balls 13 are not held in place, they cannot be moved to a releasable position, and thus elimination of the product theft prevention apparatus frequently fails.

Furthermore, the permanent magnet may substantially lose its magnetic force overtime, and when the constraint of the locking portion 210 is released by applying an excessive force while the locking balls 13 are not moved to the proper position, for prompt elimination thereof, the tapered cover 12 may be damaged and the constraint may not be easily released when the product theft prevention apparatus is reused.

In addition, as described above, when the product theft prevention apparatus is not eliminated in a short time, the product purchaser may feel dissatisfactory, which may result in a decline in the sale.

Meanwhile, FIG. 2 is a perspective view illustrating a structure of a theft prevention tag disclosed in Japanese Patent Application Publication No. 2008-204218.

The theft prevention tag 10 of FIG. 2 has a structure in which constraint of a wire 13 may be released by inserting a portion of the theft prevention tag 10 into a pocket P1 recessed in an unlocking tool 24 and by using a magnetic force of a magnet 26 provided in the interior of a casing 25.

However, because the theft prevention tag 10 also has a structure that releases the constraint of a wire 13 by using a magnetic force, it is necessary to insert a portion of the theft prevention tag 10 into the unlocking tool 24, and accordingly, it takes much time and a lot of efforts to eliminate the tag.

In addition, in recent years, a small-scale magnet having a high magnetic force has been developed, and when the small-scale magnet is wrongly used, the constraint may be easily released, deteriorating the effectiveness of the prevention of theft.

Moreover, the conventional technologies can perform only a theft prevention function while being attached to products, but it is impossible to expect an advertising effect.

### SUMMARY OF THE INVENTION

Therefore, the present invention has been made in an effort to solve the above-mentioned problems, and provides a product theft prevention tag that permits unmanned automatic payment by by producing electric power by itself by using sunlight and releasing constraint of a security key by using a power supply thereof when a signal is received from the outside.

The present invention also provides a product theft prevention tag that creates a purchasing need by operating a detection sensor with a power supply thereof and generating a sound when a consumer approaches the product theft prevention tag.

The present invention also provides a product theft prevention tag that can maximize a theft prevention effect by releasing a constraint of a security key only when electric power instead of a magnetic force is supplied thereto, and can prevent loss of the security key.

In accordance with an aspect of the present invention, there is provided a product theft prevention tag including: a security key in which a security tag is installed; a security key locker that accommodates and constrains a portion of the security key to maintain a locked state, and releases the locked state when an electric voltage is applied thereto; a product constraining wire that connects the security key and the security key locker; a unique ID chip containing product information; and a power generation unit that converts light to electric power.

A proximity sensor that receives electric power from the power generation unit and detects proximity of a moving object is installed on one side of the security key or the security key locker.

An alarm unit that generates any one of sound and light when the proximity sensor detects the moving object is installed on one side of the security key or the security key locker.

The security key locker includes: a key constraint member that is inserted into a constraint recess formed in the security key to constrain the security key; a constraint releasing unit that is connected to the key constraint member to move the location of the key constraint member and release the locked state when electric power is applied by the power generation unit; and a return spring that allows the key constraint member to return to the locked position when the electric power supplied to the constraint releasing unit is interrupted.

The security key locker includes: a key constraint member that is inserted into a constraint recess formed in the security key to constrain the security key; a storage battery that stores the electric power generated by the power generation unit; a constraint releasing unit that is connected to the key constraint member to move the location of the key constraint member and release the locked state when electric power is applied by the storage battery; and a return spring that allows the key constraint member to return to the locked position when the electric power supplied to the constraint releasing unit is interrupted.

The security key locker includes: a key constraint member that is inserted into a constraint recess formed in the security key to constrain the security key; a constraint releasing unit that is connected to the key constraint member to move the location of the key constraint member and release the locked state with the electric power received in a magnetic resonance manner; and a return spring that allows the key constraint member to return to the locked position when the electric power supplied to the constraint releasing unit is interrupted.

The product theft prevention tag further includes: a signal reception unit that receives a release signal for releasing the constraint of the security key locker.

The product theft prevention tag further includes: a switch that is installed on one side of the security key locker to selectively interrupt a power supply function of the constraint releasing unit.

The constraint releasing unit includes: a constraint releasing motor that is rotated by the electric power supplied through the security key separation unit; a traverse cam that converts rotation to linear reciprocation while synchronously rotating together with the constraint releasing motor; and a wire one side of which is connected to the key constraint member and an opposite side of which is connected to the traverse cam.

The constraint releasing unit includes: an electromagnet that generates a magnetic force when the electric power is supplied through the security key separation unit, and wherein the key constraint member is formed of a material including steel to be moved by an attractive force when the electromagnet is operated.

The switch is exposed to the outside of the security key locker to restrict the operation of a proximity sensor or a sound generation unit.

### BRIEF DESCRIPTION OF THE DRAWINGS

FIG. 1 is a sectional view illustrating an operational structure of the product theft prevention apparatus disclosed in Korean Utility Model No. 20-0274007;

FIG. 2 is a perspective view illustrating a structure of a theft prevention tag disclosed in Japanese Patent Application Publication No. 2008-204218;

FIG. 3 is a schematic diagram illustrating an example of using a product theft prevention tag according to the present invention;

FIG. 4 is a view illustrating an in-use state for generating electric power in the product theft prevention tag according to the present invention;

FIG. 5 is a schematic diagram illustrating an external configuration of the product theft prevention tag according to the present invention;

FIG. 6 is a detailed view illustrating an internal configuration of a first example of a constraint releasing unit of the product theft prevention tag according to the present invention;

FIG. 7 is a detailed view illustrating an internal configuration of a second example of constraint releasing unit of the product theft prevention tag according to the present invention;

FIG. 8 is a detailed view illustrating a configuration of a first example of a security key and a security key locker of the product theft prevention tag according to the present invention;

FIG. 9 is a detailed view illustrating a configuration of a second example of a security key and a security key locker of the product theft prevention tag according to the present invention;

FIG. 10 is a detailed view illustrating a configuration of a third example of a security key and a security key locker of the product theft prevention tag according to the present invention; and

FIG. 11 is a schematic diagram illustrating an example of an unmanned payment by using a product theft prevention tag according to the present invention.

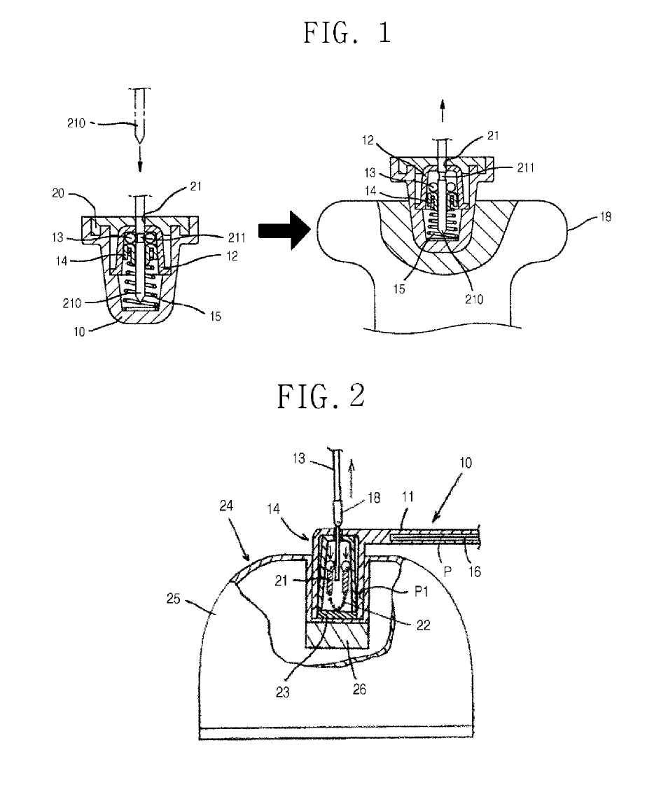

### DETAILED DESCRIPTION OF THE PREFERRED EMBODIMENTS

The product theft prevention tag according to the present invention is configured to be separated from a product by an internal or external power supply.

Further, the product theft prevention tag is configured such that an electric voltage is applied only when the product theft prevention tag receives a signal transmitted from an external device that has recognized a unique ID chip (electric wave barcode).

Furthermore, the present invention includes an embodiment in which electric power that is necessary when a signal transmitted from the external device is received and a security key is separated is supplied through magnetic resonance type power generation.

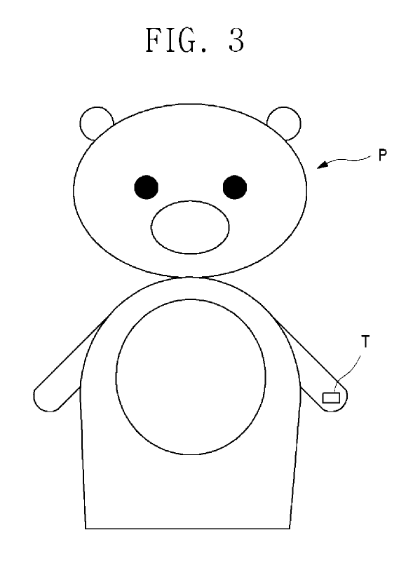

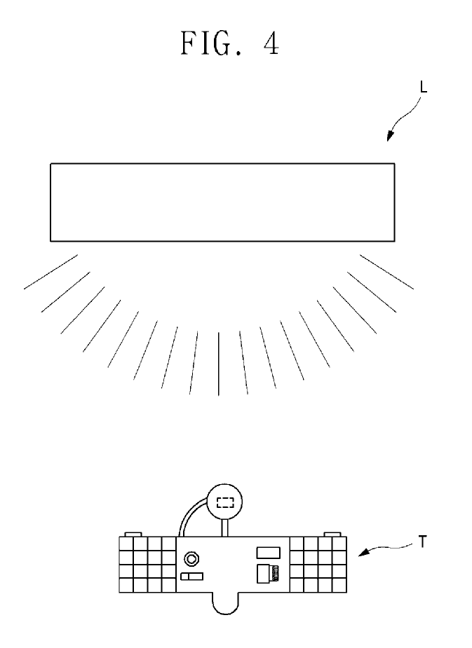

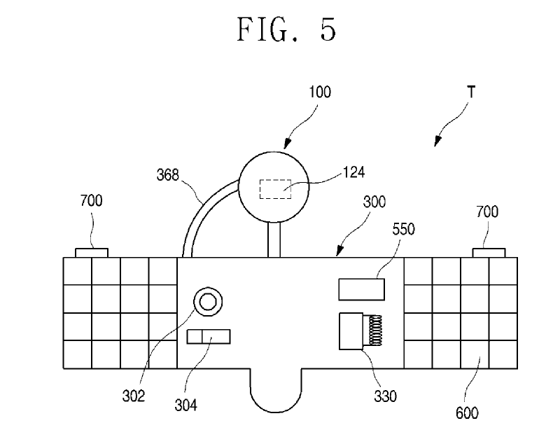

Hereinafter, an example of using a product theft prevention tag according to the present invention will be described with reference to FIGS. 3 and 4.

FIG. 3 is a schematic diagram illustrating an example of using a product theft prevention tag according to the present invention. FIG. 4 is a schematic diagram illustrating an example of generating electric power prevention tag according to the present invention.

Prior to the description of the present invention, it will be noted that the terms and wordings used in the specification and the claims should not be construed as general and lexical meanings, but should be construed as the meanings and concepts that agree with the technical spirits of the present invention, based on the principle stating that the concepts of the terms may be properly defined by the inventor(s) to describe the invention in the best manner.

Therefore, because the examples described in the specification and the configurations illustrated in the drawings are merely for the preferred embodiments of the present invention but cannot represent all the technical sprints of the present invention, it should be understood that various equivalents and modifications that may replace them can be present.

As illustrated in the drawings, the product theft prevention tag T according to the present invention is coupled to one side of a product to prevent theft of the product P, and when a moving object approaches the product theft prevention tag T, the product theft prevention tag T detects the fact and generates light or a sound, thereby increasing the purchasing need.

Furthermore, the present invention can detect a moving object using peripheral light as energy or generates light or a sound, and also performs a function of releasing a theft preventing function after the payment is made when the purchaser passes by the registration site after shopping.

Accordingly, the product theft prevention tag T generates power with the sunlight to be operated, and a lamp L having a wavelength similar to that of the sunlight can installed in the interior of a large scale market to be used as a power source.

Hereinafter, a schematic configuration of the product theft prevention tag T will be described with reference to FIG. 5.

FIG. 5 is a schematic diagram illustrating an external appearance of the product theft prevention tag T according to the present invention.

As illustrated in the drawing, the product theft prevention tag T includes a security key 100 having a security tag 124 therein, a security key locker 300 that accommodates and constrains a portion of the security key 100 to maintain a locked state and releases the locked state when an electric voltage is applied thereto, a wire 368 that connects the security key 100 and the security key locker 300 to constrain a product P, a unique ID chip 550 having information of the product P, a power generation unit 600 that converts light to electric power, a proximity sensor 302 that receives electric power from the power generation unit 600 to detect proximity of a moving object, and an alarm unit 700 that generates any one of sound and light when the proximity sensor 302 detects the moving object.

A portion of the security key 100 is inserted into the security key locker 300 to be locked, and the security key locker 300 is prevented from being separated due to the wire 368.

The unique ID chip 550 has unique identification information of the product P, and includes various pieces of information such as manufacturer, product name, price, manufacturing date, and expiration date in the form of an electric wave barcode, and various variations may be made in a method, such as an RFID tag or an NFC tag, in which unique identification information may be contained.

The power generation unit 600 generates electric power when receiving light from the outside, and is configured to supply electric power to the proximity sensor 302 and the alarm unit 700.

The power generation unit 600 is not limited to a unit that generates electric power through the sunlight, but may function to generate electric power through a lamp having a wavelength similar to that of the sunlight.

A switch 304 is installed in the security key locker 300. The switch 304 is configured such that the manager may directly stop the remaining functions other than a theft prevention function that is the basic function of the product theft prevention tag T, and for example, the proximity sensor 302 or the alarm unit 700 may correspond thereto.

Accordingly, it is preferable that the switch 304 may be exposed to the outside to be directly manipulated by the manager, and the switch 304 is electrically connected to the proximity sensor 302 and the alarm unit 700 such that the proximity sensor 302 and the alarm unit 700 may be interrupted from the power generation unit 600.

The alarm unit 700 is adapted to increase the purchasing need of the consumer in association with the proximity sensor 302, which is possible because the effect or price discount information of the product P may be guided with sound or light.

The alarm unit 700 may generate an alarm sound when the security tag 124 is taken out of the market.

A signal reception unit 330 is further installed in the security key locker 300. The signal reception unit 330 is adapted to receive a release signal for releasing constraint of the security key locker 300, and when the signal reception unit 330 receives a release signal, the security key locker 300 releases the constraint of the security key 100.

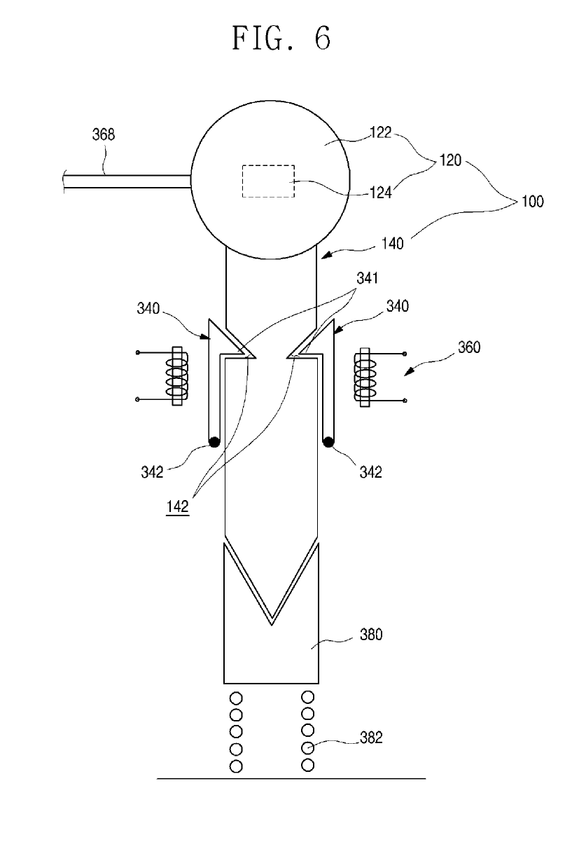

Hereinafter, a detailed configuration of the security key 100 and the constraint releasing unit 360 will be described with reference to FIG. 6.

FIG. 6 is a detailed view illustrating an internal configuration of a first example of the constraint releasing unit 360 of the product theft prevention tag T according to the present invention.

As illustrated in the drawings, the security key 100 includes a tag part 120 configured such that the security tag 124 is installed in the interior of a tag housing 122, and a locking key 140 that is formed downwards from the tag part 120 lengthily to be accommodated in the interior of the security key locker 300.

A constraint recess 142 that is recessed inwards is formed on a side surface of the locking key 140.

The constraint recess 142 may be formed on both the left and right side surfaces of the locking key 140, and has a shape corresponding to a key constraint member 340, which will be described below.

Meanwhile, the locking key 140 formed as described above is constrained and fixed when being inserted into the security key locker 300 to a predetermined depth.

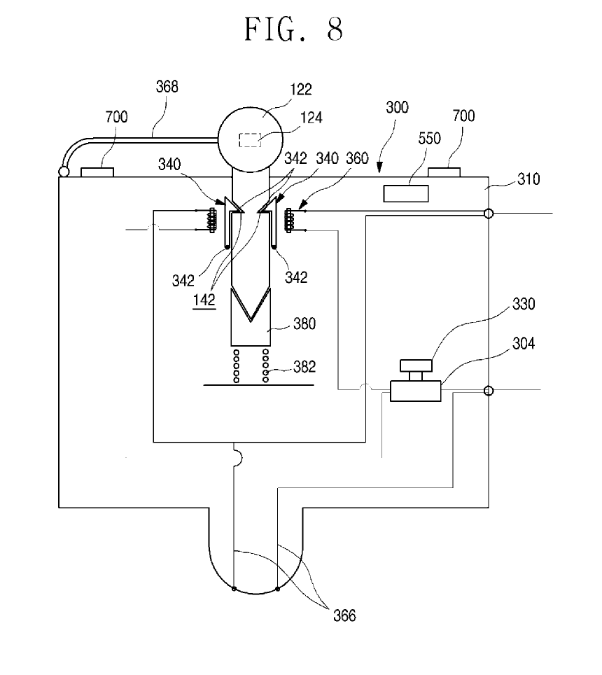

To achieve this, the security key locker 300 includes a main body 310 (see FIG. 8) that defines an external appearance, a key constraint member 340 that constrains the locking key 140 in the interior of the main body 310, a constraint releasing unit 360 that is connected to the key constraint member 340 to release a constraint force of the key constraint member 340 when electric power is supplied thereto, and a return spring 342 that returns the key constraint member 340 to an initial position after the supply of electric power is interrupted.

In detail, a key accommodation hole (not illustrated) is punched on the upper surface of the main body 310 such that the locking key 140 may be accommodated in the key accommodation hole (not illustrated), and a push rod 380 and an urging spring 382 that perform an impact absorbing and pressing function while restricting the insertion depth of the locking key 140 is provided in the interior of the key accommodation hole (not illustrated).

The upper end of the push rod 380 has a shape corresponding to that of the lower end of the locking key 140, and when the locking key 140 is inserted, the push rod 380 resiliently compresses the pressing spring 382 that is provided below the push rod 380 and is pressed downwards while being combined with the push rod 380.

Furthermore, if the constraint of the locking key 140 is released, the push rod 380 is pushed upwards while the pressing spring 382 exhibits the resilient restoring force of the pressing spring 382

Then, the push rod 380 pushes the locking key 140 upwards, and when the upward force is applied to the locking key 140, the constraint force of the key constraint member 340 inserted into the constraint recess 142 becomes firmer.

Meanwhile, the key constraint member 340 has a hook shape including an inclined surface and a vertical surface such that the upper end thereof may be fixedly stopped by the constraint recess 142.

Accordingly, after the key constraint member 340 is inserted into the constraint recess 142, the vertical surface of the key constraint member 340 perpendicular to the inclined surface thereof is stopped by and fixed to the constraint recess 142 so that the locking key 140 is restrained from being withdrawn upwards.

A return spring 342 that presses the key constraint member 340 towards the locking key 140, into which the upper end of the key constraint member 340 is inserted, while forming a center of rotation at the upper end of the key constraint member 340 is provided at the lower end of the key constraint member 340.

That is, when the locking key 140 is inserted, the return spring 342 forces the upper end of the key constraint member 340 to be pressed towards the locking key 140 without being pushed to the outside.

Accordingly, the upper end of the key constraint member 340 is easily pushed into the constraint recess 142 by the resiliency of the return spring 342, and thus the key constraint member 340 may return to the initial position even after the locking key 140 is unlocked.

Consequently, the key constraint member 340 may exhibit a firm constraint force by the resiliencies of the return spring 342 and the pressing spring 382.

The constraint releasing unit 360 is configured to extract the key constraint member 340 from the constraint recess 142, and various embodiments are possible.

First, referring to FIG. 6, the constraint releasing unit 360 may employ an electromagnet. Referring to the drawing, in the first embodiment of the present invention, an electromagnet is provided in the interior of the main body 310 of the security key locker 300 as the constraint restraining unit 360 for releasing the constraining force of the key constraint member 340.

Furthermore, because the key constraint member 340 is formed of a material including steel, the constraining force of the key constraint member 340 may be released as the key constraint member 340 is escaped from the constraint recess 142 by an attractive force if electric power is supplied to the key constraint member 340.

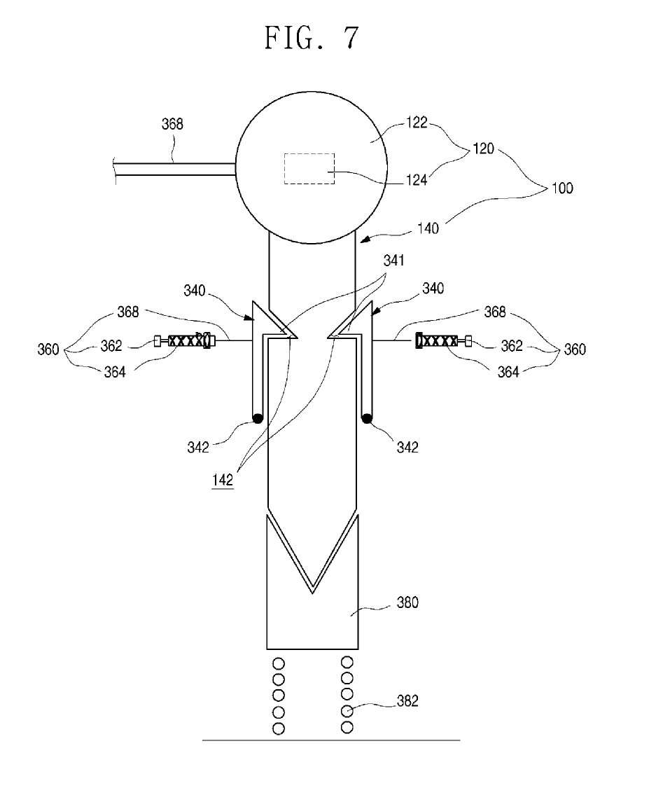

Hereafter, a configuration of another example of the constraint releasing unit 360 will be described with reference to FIG. 7.

FIG. 7 is a detailed view illustrating an internal configuration of a second example of the constraint releasing unit of the product theft prevention tag T according to the present invention.

As illustrated in the drawing, the constraint releasing unit 360 includes a constraint releasing motor 362 that generates a rotational force when receiving electric power, a traverse cam 364 that is rotated in conjunction with the constraint releasing motor 362, and a wire one side of which is connected to the upper end of the key constraint member 340 and an opposite side of which is wound on the traverse cam 364.

The constraint releasing motor 362 may be a small-scale DC step motor.

Meanwhile, the traverse cam 364 that is synchronously rotated with the constraint releasing motor 362 is configured to vary rotation of the constraint releasing motor 362 to linear reciprocation, and if an electric voltage is applied, the traverse cam 364 may rotate the key constraint member 340 by pulling the upper end of the key constraint member 340 while being rotated.

The traverse cam 364 is designed to have a cam shape having a movement displacement to move the key constraint member 340 to a maximum spacing location when it makes contact with the key constraint member 340 once and to move the key constraint member 340 to an initial location when it makes contact with the key constraint member 340 twice, in consideration of the applied electric voltage, so that the constraint and release of the key constraint member 340 may be selected only through the number of electrical connections.

Hereinafter, a configuration of a preferred embodiment of the power generation unit 600 will be described with reference to FIG. 8.

FIG. 8 is a detailed view illustrating a configuration of a first example of the security key 100 and the security key locker 300 of the product theft prevention tag T according to the present invention.

FIG. 8 illustrates an example configured to generate electric power using the sunlight and configured such that the power generation unit 600 is directly connected to the constraint releasing unit 360 and is selectively switched off by the switch 304 in the first embodiment of the present invention, and the power generation unit 600 is provided on the left and right sides of the security key locker 300 but only a power line is illustrated on the right side for convenience of description.

The power generation unit 600 and the constraint releasing unit 360 are connected to each other by the power line, and the switch 304 is provided on one side of the power line.

The switch 304 is configured to interrupt the power line, and is operated in conjunction with the signal reception unit 330.

That is, when the signal reception unit 330 receives a release signal for releasing the constraint of the security key locker 300, the switch 304 is switched on to directly provide the constraint releasing unit 360 with the electric power of the power generation unit 600 so that the key constraint member 340 is rotated to release the constraint of the security key 100.

The signal reception unit 330 may operate the alarm unit 700 to emit light or generate sound information when receiving a proximity signal of the moving object from the proximity sensor 302.

Accordingly, it is preferable that a controller (not illustrated) for controlling the operations of the alarm unit 700 and the key constraint member 340 according to a signal received by the signal reception unit 330 be provided on one side of the interior of the security key locker 300.

A terminal 366 is provided on the lower side of the security key locker 300. The terminal 366 is configured to supply electric power to the constraint releasing unit 360 separately from the power generation unit 600, and is configured to make contact with a separate security key separation unit (not illustrated) to receive electric power when the controller fails, or an electrical connection between the power generation unit 600 and the constraint releasing unit 360 is not smooth.

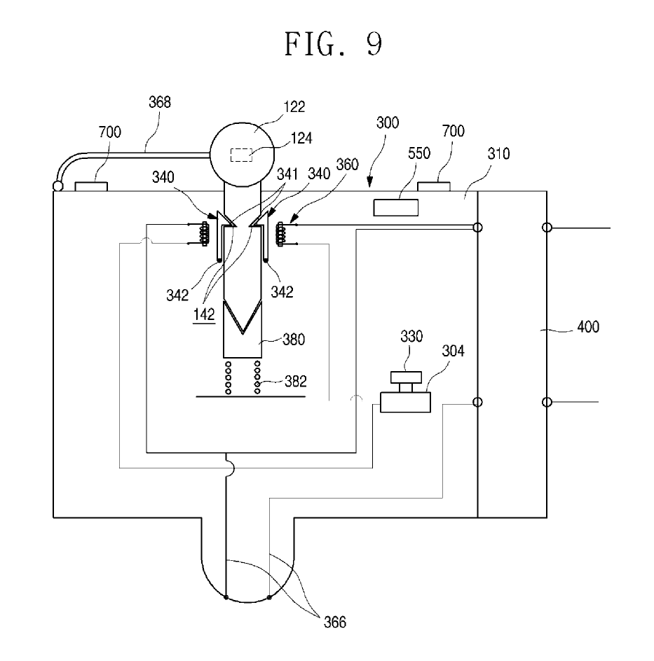

Hereinafter, the structure of a security key locker 300 according to another example will be described with reference to FIG. 9.

FIG. 9 is a detailed view illustrating a configuration of a second example of the security key 100 and the security key locker 300 of the product theft prevention tag T according to the present invention, and a storage battery 400 that stores electric power generated in the power generation unit 600 is further provided.

The storage battery 400 is electrically connected to the constraint releasing unit 360 to supply electric power to the constraint releasing unit 360, and is configured to selectively interrupt supply of electric power by the switch 304.

It is preferable that the storage battery 400 be electrically connected to the power generation unit 600 such that it may always store electric power.

The storage battery is configured to supply electric power also to the proximity sensor 302 and the alarm unit 700.

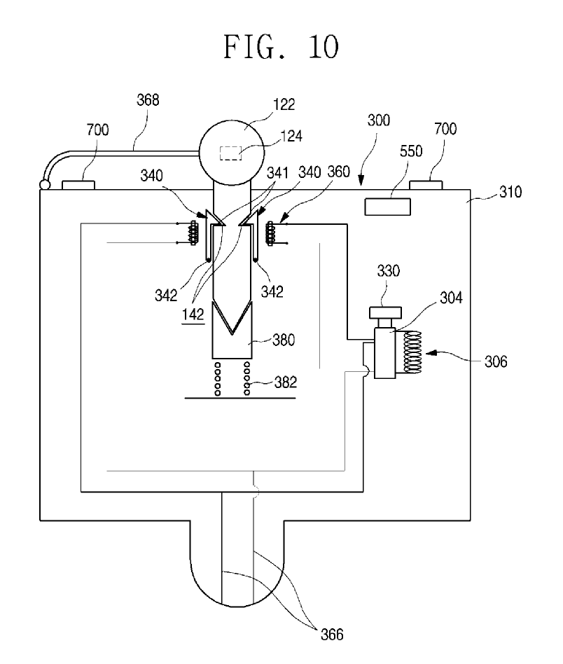

Hereinafter, the structure of a security key locker 300 according to another example will be described with reference to FIG. 10.

FIG. 10 is a detailed view illustrating a configuration of a third example of the the security key 100 and the security key locker 300 of the product theft prevention tag T according to the present invention.

As illustrated in the drawing, the constraint releasing unit 360 is connected to the key constraint member 340 and is configured to release the locked state by moving the location of the key constraint member 340 with electric power provided in a magnetic resonance manner.

That is, the constraint releasing unit 360 wirelessly receives electric power and releases the constraint of the security key 100. However, it is preferable that the proximity sensor 302 and the alarm unit 700 receive electric power in a solar power generation method, and the electric power generated in the power generation unit 600 and the electric power for the operation of the constraint releasing unit 360 are stored in the storage battery 400 at the same time to be used independently.

A power reception unit 306 is provided on the right side of the interior of the security key locker 300. The power reception unit 306 is configured to receive electric power (resonance frequency) from a power transmission unit separately provided on the outside, and is electrically connected to the constraint releasing unit 360 and is configured to be selectively interrupted by the switch 304.

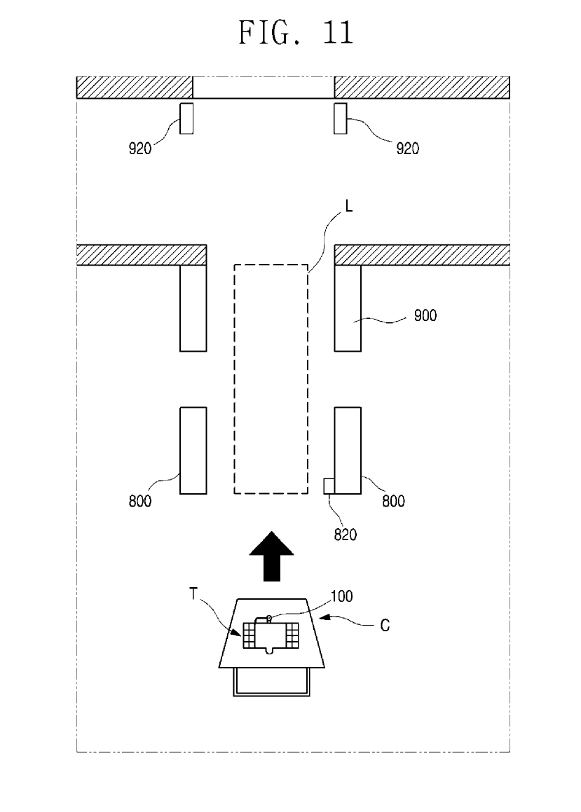

Hereinafter, an example of using the product theft prevention tag will be described with reference to FIG. 11.

FIG. 11 is a schematic diagram illustrating an example of an unmanned payment using the product theft prevention tag according to the present invention, and illustrates a situation in which a product, to which the product theft prevention tag is attached, is carried out of a large scale mart.

That is, if a purchaser pushes a cart containing the product theft prevention tag to approach a chip detection unit 800, the chip detection unit 800 detects a unique ID chip 550. Then, the detected product information of the unique ID chip 550 is displayed on a display of a payment machine 820.

Thereafter, the purchaser pays for the product with his or her credit card or the like after identifying the displayed product information, and then the chip detection unit 800 provides the signal reception unit 330 with a signal.

The signal which the signal reception unit 330 receives from the chip detection unit 800 is a release signal for releasing the constraint of the security key locker 300, and the signal reception unit 300 delivers the signal to the controller (not illustrated) and operates the constraint releasing unit 360.

The constraint releasing unit 360 may receive electric power from the storage battery 400, may receive electric power directly from the power generation unit 600, and may receive wireless power from a power transmission unit 900.

It is preferable that a plurality of lamps L be installed in the progress direction of the cart C in the vicinity of the payment machine 820 so that the power generation unit 600 produces more electric power to help smoothly supply electric power, and the constraint releasing unit 360 may be separated from the product by releasing the constraint of the security key 100 via the process.

Meanwhile, the product theft prevention tag T that has been separated from the product may be lost by a mistake or an intention of the purchaser.

Accordingly, it is preferable that a carrying out detection unit 920 be installed to prevent the product theft prevention tag T from being carried out of the market even if the product theft prevention tag T is extracted from the power transmission unit 900 while the product is contained in the cart C.

The carrying out detection unit 920 is installed at an escalator, an elevator, or an entrance of the market, where the product is not exhibited, to detect the security tag 124 such that the security tag 124 is not carried out to the outside through an alarm sound, and the product theft prevention tag T may be retrieved and recycled in various methods.

For example, a collection box is provided beside an autonomous packaging facility to allow the purchaser to introduce the product theft prevention tag T into the collection box so that the product theft prevention tag T can be retrieved, and the product theft prevention tag T may be kept in a cart keeping site while being contained in the cart C.

As a measure to activate the retrieval of the product theft prevention tag T, an envelope that may contain the product may be provided when the consumer returns the product theft prevention tag T to the consumer center.

According to the present invention, the product theft prevention tag permits unmanned automatic payment by producing electric power by itself by using sunlight and releasing constraint of a security key by using a power supply thereof when a signal is received from the outside.

Accordingly, convenience of use can be improved.

Further, according to the present invention, the product theft prevention tag can create a purchasing need by operating a detection sensor with a power supply thereof and generating a sound when a consumer approaches the product theft prevention tag.

In addition, the product theft prevention tag can maximize a theft prevention effect by releasing a constraint of a security key only when electric power instead of a magnetic force is supplied thereto, and can prevent loss of the security key.

The scope of the present invention is not limited to the exemplified embodiments, and the present invention may be variously modified without departing from the scope of the present invention.

1. A product theft prevention tag comprising:
a security key in which a security tag is installed;
a security key locker that accommodates and constrains a portion of the security key to maintain a locked state, and releases the locked state when an electric voltage is applied thereto;
a product constraining wire that connects the security key and the security key locker;
a unique ID chip containing product information; and
a power generation unit that converts light to electric power.

2. The production theft prevention tag of claim 1, wherein a proximity sensor that receives electric power from the power generation unit and detects proximity of a moving object is installed on one side of the security key or the security key locker.

3. The product theft prevention tag of claim 2, wherein an alarm unit that generates any one of sound and light when the proximity sensor detects the moving object is installed on one side of the security key or the security key locker.

4. The product theft prevention tag of claim 3, wherein the security key locker comprises:
a key constraint member that is inserted into a constraint recess formed in the security key to constrain the security key;
a constraint releasing unit that is connected to the key constraint member to move the location of the key constraint member and release the locked state when electric power is applied by the power generation unit; and
a return spring that allows the key constraint member to return to the locked position when the electric power supplied to the constraint releasing unit is interrupted.

5. The product theft prevention tag of claim 3, wherein the security key locker comprises:
a key constraint member that is inserted into a constraint recess formed in the security key to constrain the security key;
a storage battery that stores the electric power generated by the power generation unit;
a constraint releasing unit that is connected to the key constraint member to move the location of the key constraint member and release the locked state when electric power is applied by the storage battery; and
a return spring that allows the key constraint member to return to the locked position when the electric power supplied to the constraint releasing unit is interrupted.

6. The product theft prevention tag of claim 3, wherein the security key locker comprises:
a key constraint member that is inserted into a constraint recess formed in the security key to constrain the security key;
a constraint releasing unit that is connected to the key constraint member to move the location of the key constraint member and release the locked state with the electric power received in a magnetic resonance manner; and
a return spring that allows the key constraint member to return to the locked position when the electric power supplied to the constraint releasing unit is interrupted.

7. The product theft prevention tag of claim 4, further comprising: a signal reception unit that receives a release signal for releasing the constraint of the security key locker.

8. The product theft prevention tag of claim 4, further comprising: a switch that is installed on one side of the security key locker to selectively interrupt a power supply function of the constraint releasing unit.

9. The product theft prevention tag of claim 4, wherein the constraint releasing unit comprises:
a constraint releasing motor that is rotated by the electric power supplied through the security key separation unit;
a traverse cam that converts rotation to linear reciprocation while synchronously rotating together with the constraint releasing motor; and
a wire one side of which is connected to the key constraint member and an opposite side of which is connected to the traverse cam.

10. The product theft prevention tag of claim 4, wherein the constraint releasing unit comprises: an electromagnet that generates a magnetic force when the electric power is supplied through the security key separation unit, and wherein the key constraint member is formed of a material comprising steel to be moved by an attractive force when the electromagnet is operated.

11. The product theft prevention tag of claim 8, wherein the switch is exposed to the outside of the security key locker to restrict the operation of a proximity sensor or a sound generation unit.

12. The product theft prevention tag of claim 5, further comprising: a signal reception unit that receives a release signal for releasing the constraint of the security key locker.

13. The product theft prevention tag of claim 6, further comprising: a signal reception unit that receives a release signal for releasing the constraint of the security key locker.

14. The product theft prevention tag of claim 5, further comprising: a switch that is installed on one side of the security key locker to selectively interrupt a power supply function of the constraint releasing unit.

15. The product theft prevention tag of claim 6, further comprising: a switch that is installed on one side of the security key locker to selectively interrupt a power supply function of the constraint releasing unit.

16. The product theft prevention tag of claim 5, wherein the constraint releasing unit comprises:
a constraint releasing motor that is rotated by the electric power supplied through the security key separation unit;
a traverse cam that converts rotation to linear reciprocation while synchronously rotating together with the constraint releasing motor; and
a wire one side of which is connected to the key constraint member and an opposite side of which is connected to the traverse cam.

17. The product theft prevention tag of claim 6, wherein the constraint releasing unit comprises:
a constraint releasing motor that is rotated by the electric power supplied through the security key separation unit;
a traverse cam that converts rotation to linear reciprocation while synchronously rotating together with the constraint releasing motor; and
a wire one side of which is connected to the key constraint member and an opposite side of which is connected to the traverse cam.

18. The product theft prevention tag of claim 5, wherein the constraint releasing unit comprises: an electromagnet that generates a magnetic force when the electric power is supplied through the security key separation unit, and wherein the key constraint member is formed of a material comprising steel to be moved by an attractive force when the electromagnet is operated.

19. The product theft prevention tag of claim 6, wherein the constraint releasing unit comprises: an electromagnet that generates a magnetic force when the electric power is supplied through the security key separation unit, and wherein the key constraint member is formed of a material comprising steel to be moved by an attractive force when the electromagnet is operated.
